(19) United States
(12) Patent Application Publication
(10) Pub. No.: US 2005/0056113 A1
(43) Pub. Date: Mar. 17, 2005

(54) Flexible sleeve for covering linkages and method

(76) Inventor: Jeffery S. Bovid, Nunica, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/931,715

(22) Filed: Sep. 1, 2004

Related U.S. Application Data
(60) Provisional application No. 60/499,491, filed on Sep. 2, 2003.

(51) Int. Cl. F16B 4/00

(52) U.S. Cl. 74/502.5

(57) ABSTRACT

A linkage for vehicle doors and the like includes an elongated wire adapted to interconnect a handle and a lock or other such components in a vehicle door. The linkage includes a sleeve covering at least a portion of the wire. The sleeve is made of a thermoplastic fabric material folded around the wire with opposite edge portions sonically welded or otherwise melted to each other.

### CROSS-REFERENCE TO RELATED APPLICATIONS

The present application claims the benefit of U.S. Provisional Patent Application No. 60/499,491, filed Sep. 2, 2003, entitled FLEXIBLE SLEEVE FOR WIRES, the entire contents of which is hereby incorporated by reference.

### BACKGROUND OF THE INVENTION

Linkages in vehicle doors commonly include a formed wire that extends between the lock mechanism and the release latch for the door. There is often limited space available for the wire, such that the wire is formed to fit closely around other internal components of the door. Due to the close proximity of the wire to the other internal components, rattling, squeaks and the like can be caused by contact between the wire and the other internal components. In an effort to reduce or eliminate this problem, various sleeves for covering the wire have been developed.

For example with reference to FIGS. 1 and 2, a prior art braided sleeve 1 is made of braided paper fiber/yarns, and fits over a wire linkage or rod member 2. However, the braided sleeves are prone to fraying at the ends 3. Furthermore, such sleeves are prone to snagging and tearing during use, and/or during assembly onto the wire 2. In general, braided sleeves are a paper-based product that tends to degrade when exposed to moisture, such that the sleeves must be treated with hydraulic fluid, oil, or the like to repel moisture. Also, typical commercial specifications require that the sleeve be within +/−0.100 inches of a specified length. Maintaining such tolerances can be quite difficult due to the fraying that tends to occur with braided sleeves.

With further reference to FIGS. 3 and 4, another approach that has been utilized involves an extruded polymer sleeve 4 having an open mesh construction. Although such extruded polymer sleeves 4 reduce the fraying problems associated with braided sleeves, the extruded sleeves 4 are quite expensive to manufacture and are prone to snagging. Also, the open mesh construction of the polymer sleeve 4 leaves the linkage member 2 exposed, and therefore does not fully protect the wire linkage member 2.

Accordingly, a sleeve alleviating the problems associated with such prior art sleeves would be advantageous.

### SUMMARY OF THE INVENTION

One aspect of the present invention is a linkage for vehicle doors and the like including an elongated wire adapted to interconnect a handle and a lock or other such components in a vehicle door. The linkage includes a sleeve covering at least a portion of the wire. The sleeve is made of a thermoplastic fabric material folded around the wire with opposite edge portions sonically welded or otherwise melted to each other.

These and other features, advantages, and objects of the present invention will be further understood and appreciated by those skilled in the art by reference to the following specification, claims, and appended drawings.

### BRIEF DESCRIPTION OF THE DRAWINGS

FIG. 1 is a prior art braided sleeve;

FIG. 2 shows the sleeve of FIG. 1 on a wire adapted for use in an vehicle door;

FIG. 3 is a prior art extruded polymer sleeve;

FIG. 4 is the sleeve of FIG. 3 installed on a wire;

FIG. 5 is a partially schematic view of a vehicle door showing the internal components, including a linkage and sleeve according to one aspect of the present invention;

FIG. 6 illustrates a sleeve according to one aspect of the present invention;

FIG. 6A is a cross-sectional view of the sleeve of FIG. 6 taken along the line VIA-VIA;

FIG. 7 shows the sleeve of FIG. 6 installed on a wire;

FIG. 8 is a roll of fabric prior to folding over and sonic welding;

FIG. 9 is a partially schematic view showing sonic welding and cutting of a sleeve;

FIG. 9A shows sonic welding of a sleeve, wherein the sleeve is wound on a spool for transport prior to cutting to length;

FIG. 10 is a photograph illustrating the sonic welding apparatus and process of FIG. 9 from a different angle; and

FIG. 11 is a photograph illustrating the sonic welding apparatus and process of FIG. 9 from a different angle.

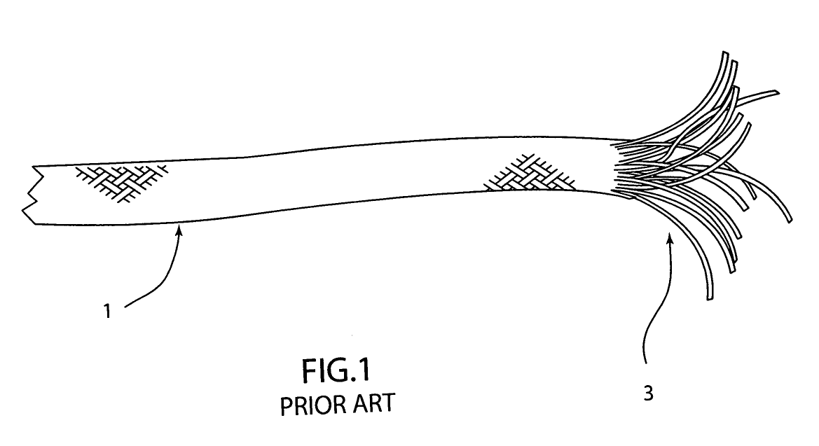

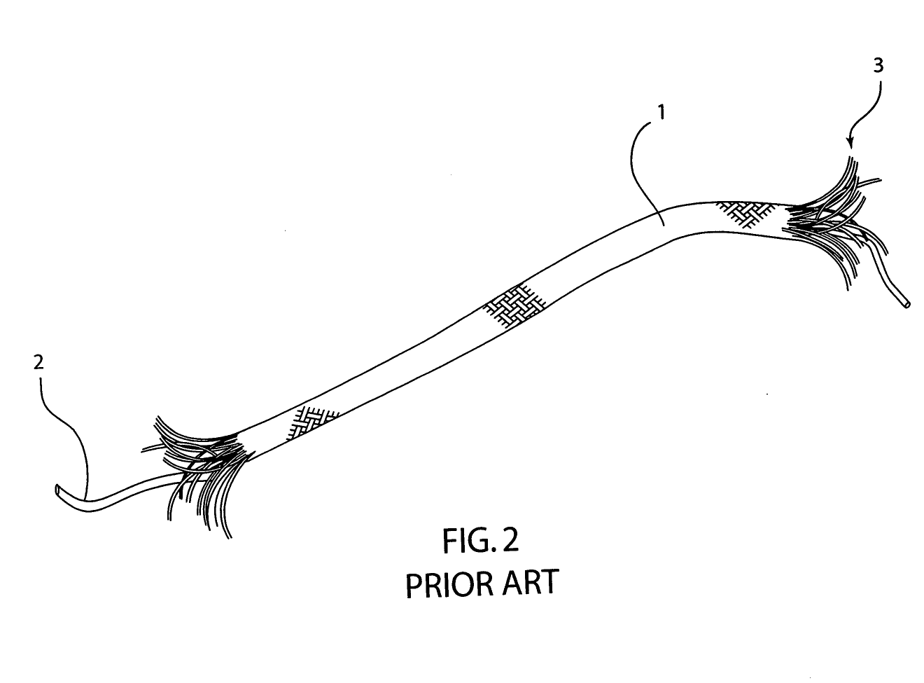

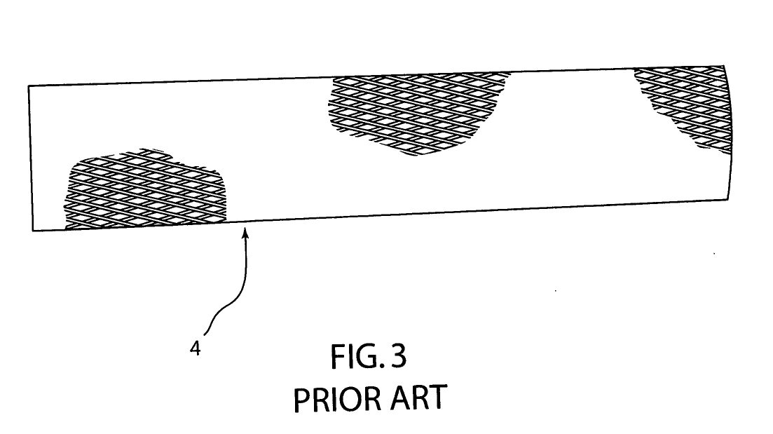

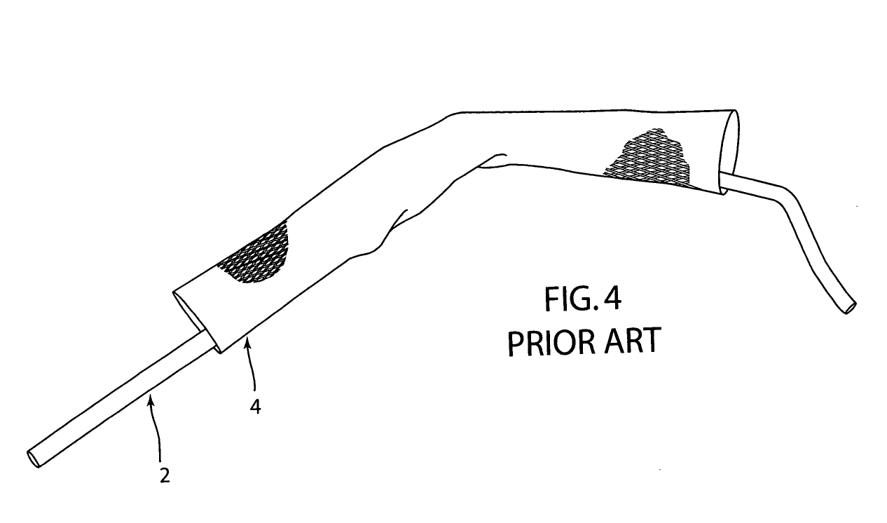

### DETAILED DESCRIPTION OF PREFERRED EMBODIMENT

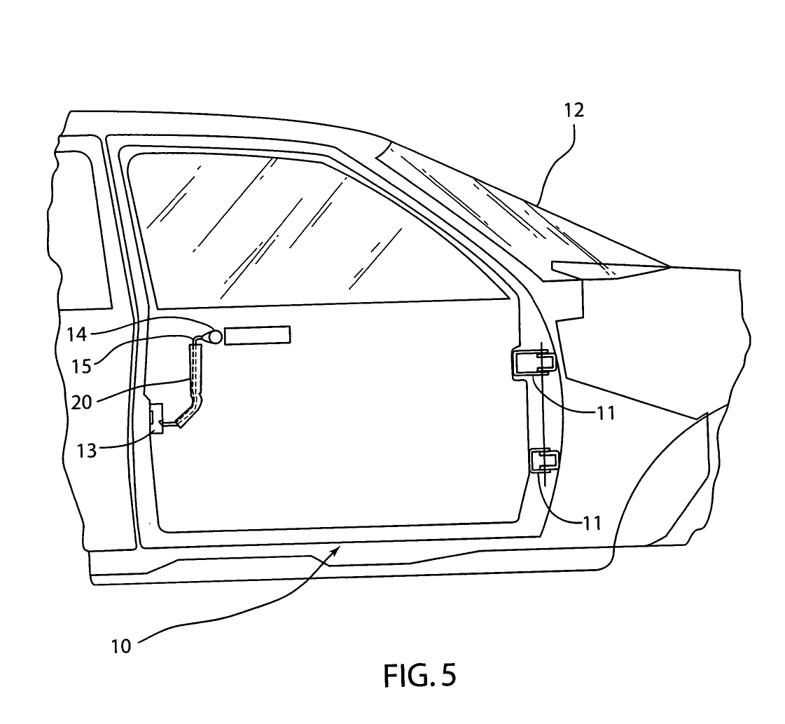

For purposes of description herein, the terms “upper,” “lower,” “right,” “left,” “rear,” “front,” “vertical,” “horizontal,” and derivatives thereof shall relate to the invention as oriented in FIG. 5. However, it is to be understood that the invention may assume various alternative orientations and step sequences, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

With reference to FIG. 5, a door 10 for vehicles such as cars, trucks or the like is mounted to a vehicle 12 by hinges 11, and a latch 13 secures the door 10 in a closed position in a known manner. A lock mechanism 14 is operably connected to the latch 13 by a wire rod or link 15 formed to fit around other internal components in the door 10. A sleeve 20 according to one aspect of the present invention fits around the wire 15 and alleviates rattles, squeaks, and the like that could otherwise result from contact between the wire 15 and the internal door components.

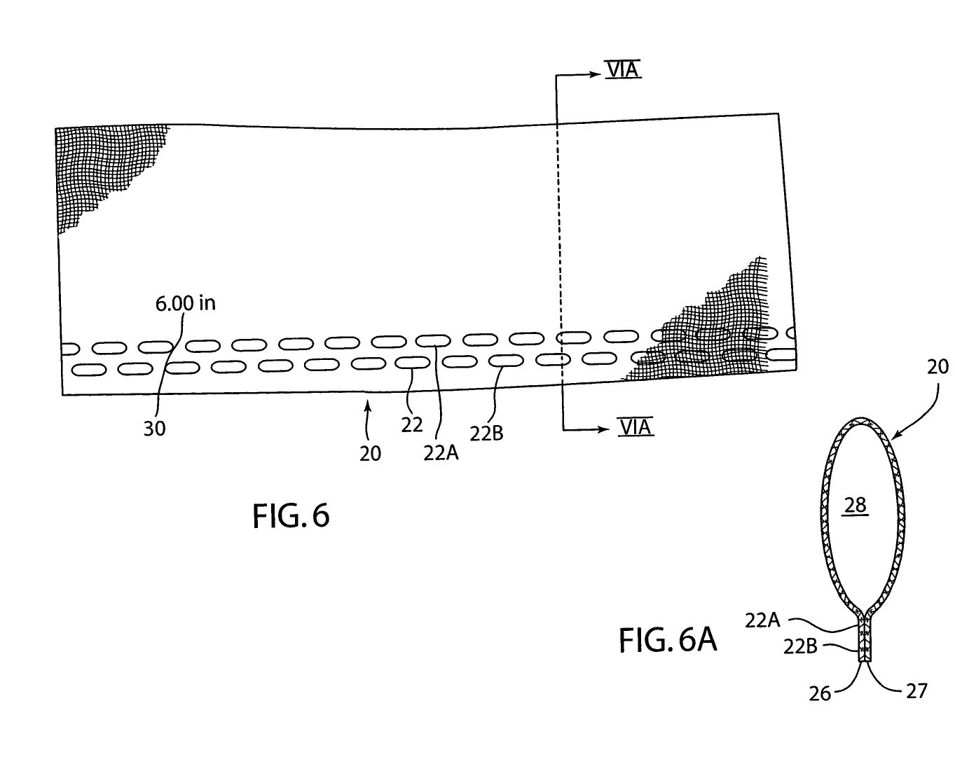

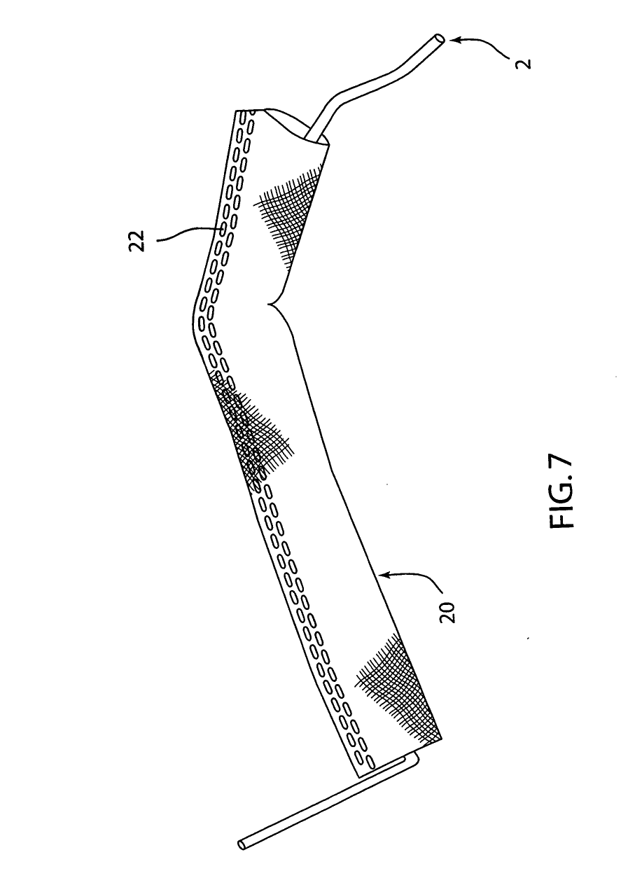

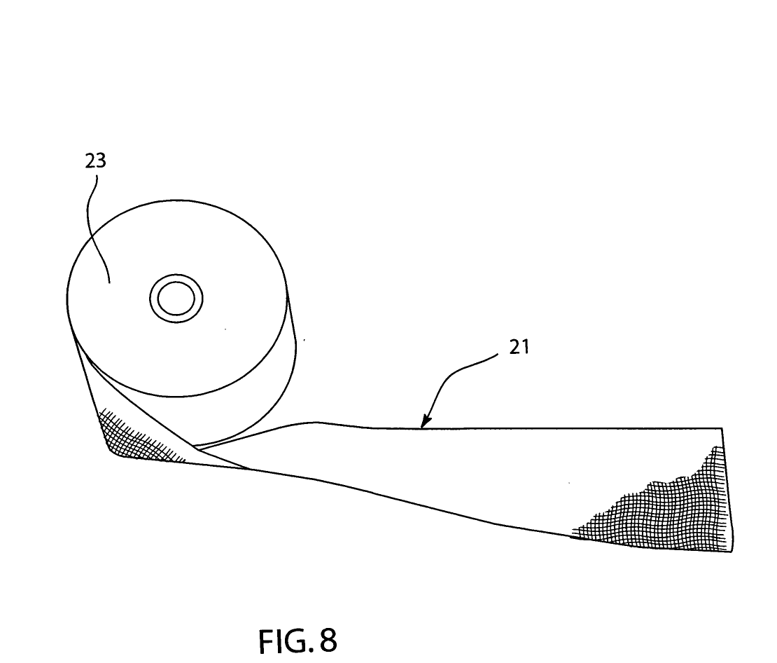

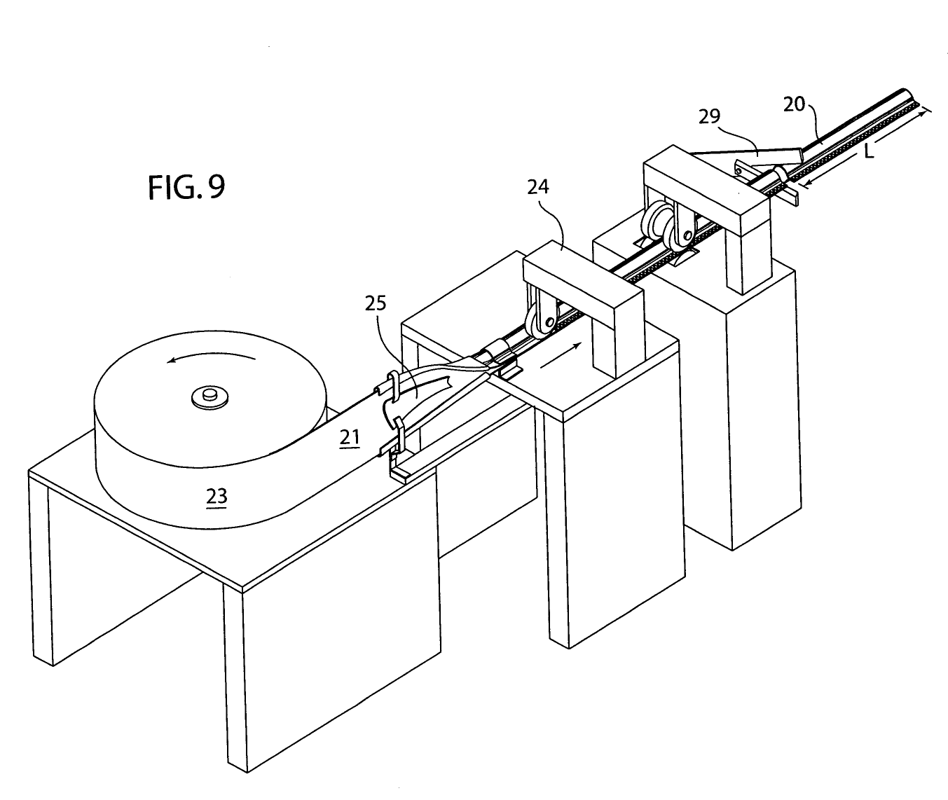

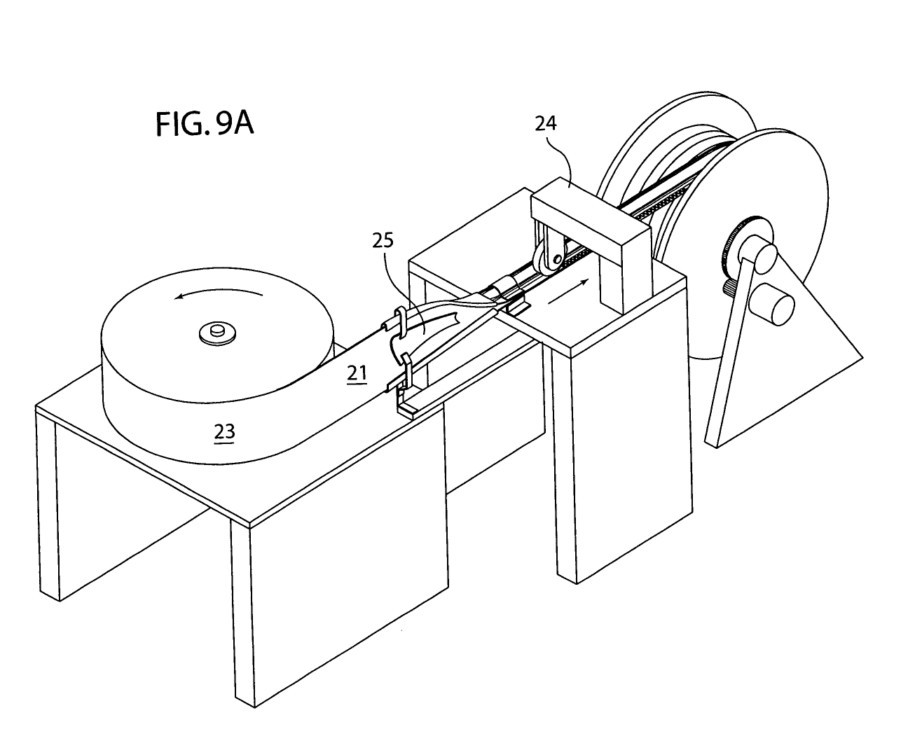

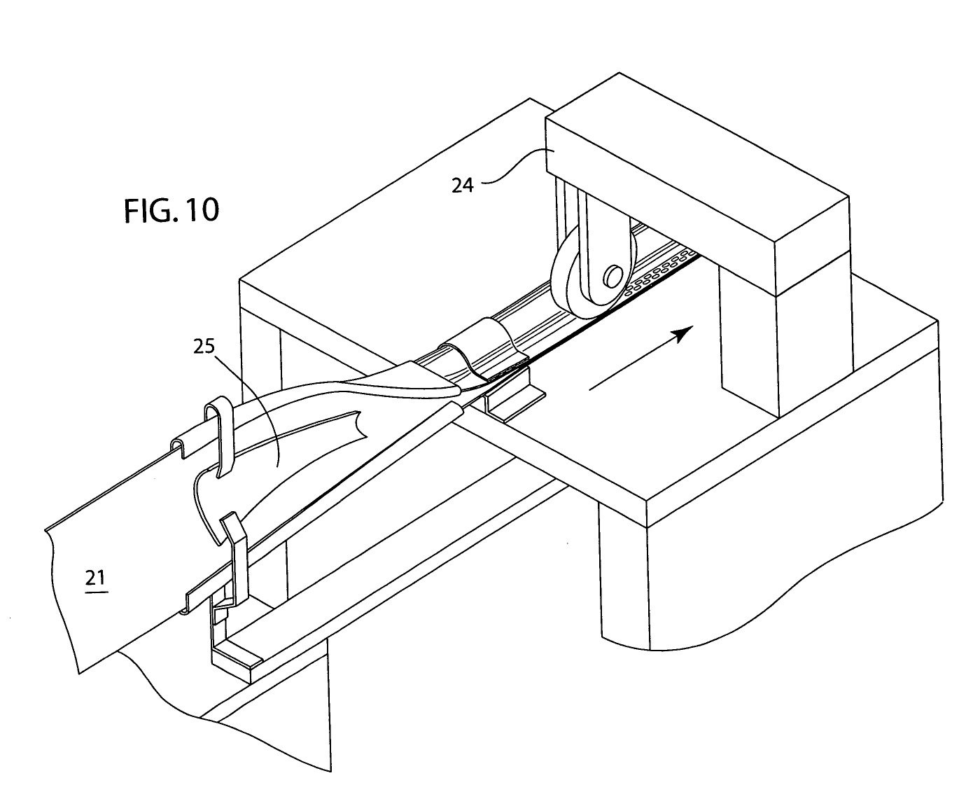

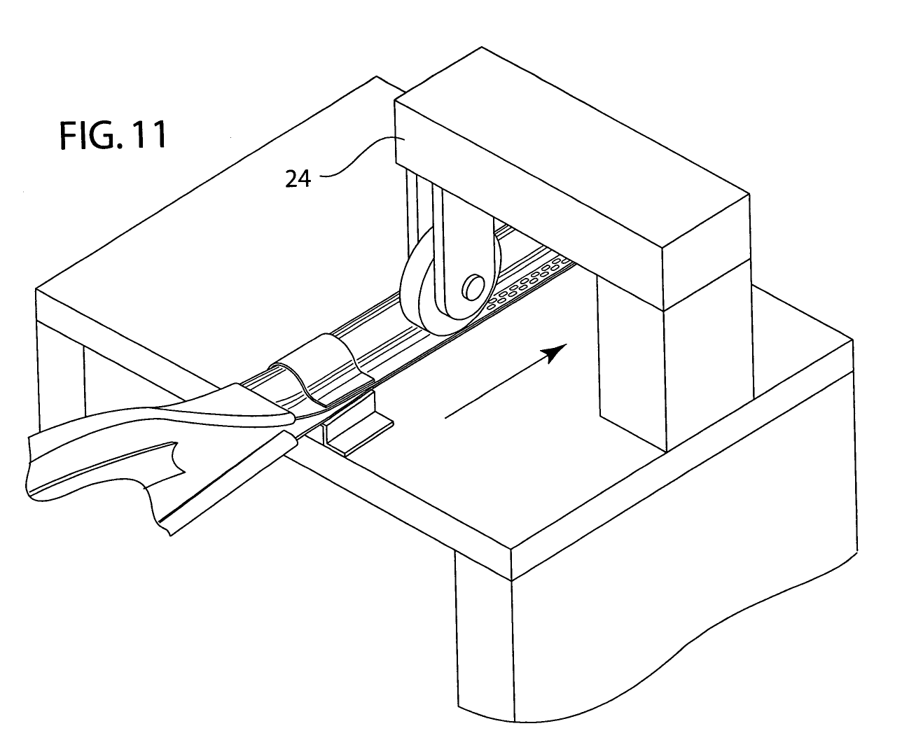

With further reference to FIG. 6, the sleeve 20 is made of a known thermoplastic fabric material such as a polypropylene fabric. An elongated strip of fabric 21 (FIG. 8) is folded over and sonically welded together adjacent edges 26 and 27 of the fabric along the line 22. Line 22 may include a first line or row of welded areas 22A and a second row of welded areas 22B. Alternately, line 22 includes a single row of welded areas, or could include three or more rows of welded areas. The edges 26 and 27 of the fabric are positioned proximate one another. Sleeve 20 forms an elongated internal cavity 28 that receives wire 15 when assembled therewith (FIG. 7). The sleeve 20 is flexible, and can therefore be flexed to accommodate wires 15 having a wide variety of bends or other shapes, examples of which are shown in FIGS. 5 and 7. The strip of material has a width chosen to provide the proper size sleeve for a given application. Sonic welding of fabric is accomplished utilizing high frequency sound to induce heat and pressure due to the vibratory action. With further reference to FIGS. 9-11, an ultrasonic weld machine 24 is utilized to weld the fabric to form welds 22A and 22B during fabrication. Such machines are available from Sonoband Ultrasonics Corporation, West Chester, Pa. During fabrication, the strip 21 is fed from the roll 23, folded over in a folder 25, and sonically welded. The resulting sleeve may be re-wound to form a new roll (FIG. 9A), or may be immediately cut to a required length “L” utilizing a scissors 29 or the like (FIG. 9A). With reference back to FIG. 7, the sleeve 20 is then slid over the wire 2, and the wire is then installed into a door 10 as illustrated in FIG. 5.

The sleeve 20 of the present invention offers substantial cost savings over known braided or extruded sleeves. Furthermore, the sleeve 20 prevents fraying of material, and the synthetic fabric utilized to construct the sleeve 20 is impervious to most common chemicals and lubricants during motor vehicle assembly and maintenance. Sleeve 20 is also impervious to moisture, such that treatment with oil or the like is not required. The overall length of the sleeve 20 can be accurately controlled because the thermoplastic fabric does not fray to any substantial extent. Also, in contrast to some prior art sleeves, the sleeve 20 of the present invention completely covers the linkage, thereby ensuring that the linkage does not contact other metal components within the vehicle door. Still further, the material of sleeve 20 can be printed on utilizing laser printing or other known printing processes. Also, the fabric utilized to make the sleeve 20 may be of a particular color to provide color coding. By marking the sleeve or providing a color code, various sized sleeves for particular applications can be marked/identified to prevent confusion during manufacture. For example, sleeves of a particular length (e.g. six inches) may be fabricated from a material of a first color, and sleeves of a second length (e.g. twelve inches) may be fabricated from a material of a second color. Alternately, the sleeve may be printed with indicia 30 providing information concerning the size of the sleeve and/or the intended application of the sleeve. In this way, sleeves of a given configuration can be marked to avoid confusion.

It will be readily understood that the sleeve 20 may be configured to cover a wide variety of links in various applications. For example, sleeve 20 may be utilized to cover links utilized in hatches of vans, SUVs, and the like, or to cover linkages utilized to open hoods, or any other links or the like requiring a cover.

In the foregoing description, it will be readily appreciated by those skilled in the art that modifications may be made to the invention without departing from the concepts disclosed herein. Such modifications are to be considered as included in the following claims, unless these claims by their language expressly state otherwise.

1. A linkage for vehicle doors and the like, comprising:
an elongated link adapted to interconnect a handle and a lock in a vehicle door;
a sleeve covering at least a portion of the link, the sleeve comprising a thermoplastic material wrapped around the link and having opposite edge portions welded together to form an elongated sleeve that substantially surrounds at least a portion of the link.

2. The linkage of claim 1, wherein:
the link is formed of an elongated wire having bands to provide clearance for internal door components.

3. The linkage of claim 1, wherein:
the edge portions are welded together utilizing sonic welding that melts the opposite edge portions of the thermoplastic material together.

4. The linkage of claim 3, wherein:
the thermoplastic material comprises a thin sheet of fabric.

5. The linkage of claim 4, wherein:
the fabric is substantially free of moisture repellent fluid.

6. The linkage of claim 1, wherein:
the thermoplastic material defines opposite edges positioned directly adjacent one another.

7. The linkage of claim 1, wherein:
the thermoplastic material has identifying indicia thereon.

8. The linkage of claim 1, wherein:
the thermoplastic material is colored.

9. A method of making a sleeve for covering linkage for vehicles, the method comprising:
providing an elongated strip of thermoplastic fabric;
folding at least a portion of the elongated strip onto itself;
welding opposite edge portions of the elongated strip together to form a sleeve.

10. The method of claim 9, wherein:
the opposite edge portions are welded utilizing ultrasonic welding.

11. The method of claim 9, including:
cutting the sleeve at a predetermined length.

12. The method of claim 11, including:
marking the sleeve with indicia to identify the sleeve.

13. The method of claim 11, wherein:
the sleeve is colored to identify the sleeve.

14. The method of claim 10, wherein:
the elongated strip of thermoplastic fabric is fed from a roll and folded immediately prior to welding in a substantially continuous process.

15. The method of claim 11, including:
providing an elongated link member;
positioning the sleeve over the elongated link member with opposite ends of the link member extending out of the sleeve.

16. The method of claim 15, including:
installing the link member in the door of a vehicle.

17. The method of claim 9, wherein:
the elongated strip has a substantially uniform width;
the opposite edge portions are welded in a straight line to form a substantially uniform cross-sectional shape along the sleeve.

18. A sleeve for covering linkages, the sleeve comprising:
an elongated strip of thermoplastic fabric defining opposite edge portions, the strip of thermoplastic fabric being folded over with the opposite edge portions contacting one another;
an elongated weld line connecting the opposite edge portions together.

19. The sleeve of claim 18, wherein:
the weld line comprises a row of discrete welded areas.

20. The sleeve of claim 18, wherein:
the sleeve has a substantially uniform cross-sectional shape.
